(19) United States
(12) Patent Application Publication
(10) Pub. No.: US 2003/0067132 A1
(43) Pub. Date: Apr. 10, 2003

(54) Folding device for a scooter

(76) Inventor: Samuel Lin, Chia Yi Hsien (TW)

Correspondence Address: Kolisch, Hartwell, Dickinson,, McCormack & Heuser, Suite 200, 520 S.W. Yamhill Street, Portland, OR, 97204-1378, US

(21) Appl. No.: 09/974,378

(22) Filed: Oct. 9, 2001

(51) Int. Cl. B62B 9/00; B62M 1/00

(52) U.S. Cl. 280/87.041; 280/655.1

(57) ABSTRACT

A folding device has a bracket, a connecting arm and a locking arm. The bracket is secured to the board. The bracket has a circular top edge and two pairs of aligned notches defined in the top of the bracket. The connecting arm is pivotally in the bracket between the notches in each pair with a pivot pin. A pin extends through the connecting arm and is received in either one of the pairs of notches in the bracket. The locking arm has two ends. One end is pivotally attached to one end of the pivot pin outside the bracket, and a notch is defined in a bottom of the other end of the locking arm. Consequently, the notch in the locking arm can engage the pin from a top of the pin. The pin is kept from disengaging from the recess. The handlebar will not unintentionally fold when the scooter is in use. The safety of using the scooter is improved.

### BACKGROUND OF THE INVENTION

1. Field of the Invention

The present invention relates to a folding device, and more particularly to a folding device for a scooter that has a locking arm on the folding device to keep the folding device from unintentionally folding or unfolding.

2. Description of Related Art

With reference to FIG. 4, a conventional foldable scooter substantially comprises a board (40), a handlebar (42), a front wheel (43) and a rear wheel (44). The handlebar (42) is pivotally attached to the front end of the board (40). The front wheel (43) is rotatably mounted on the bottom of the handlebar (42). The rear wheel (44) is rotatably mounted on the rear end of the board (40). To reduce the volume of the scooter, a folding device is mounted on the board (40) and connects to the handlebar (42).

With reference to FIGS. 4 and 5, the conventional folding device in accordance with the prior art comprises a bracket (46) and a connecting arm (47). The bracket (46) is attached to the board (40). The top of bracket (46) is a circular curve. Two pairs of notches (462) are defined in the top of the bracket (46). The connecting arm (47) is pivotally connected to the bracket (46) between the notches (462) in each pair of notches (462). A head tube (not numbered) is attached to one end of the connecting arm (47) so the handlebar (42) can rotatably extend through the head tube. A pin (48) extends through the connecting arm (47) and is selectively received in one of the pairs of notches (462) in in the bracket (46). A slot (not numbered) is defined in the connecting arm (47), a pair of aligned pivot holes (not numbered) are formed in the bracket (46). A pivot pin (not numbered) extends through the slot in the connecting arm (47) and pivot holes in the bracket (46) so that the connecting arm (47) is pivotally connected to the bracket (46) with the pivot pin.

When the handlebar (42) is pulled away from the pivot pin, the slot slides along the pivot pin, and the pin (48) disengages from the pair of notches (462) in the bracket (46). Consequently, the connecting arm (47) can be pivoted relative to the bracket (46), and the handlebar (42) is folded relative to the board (40).

However, when the user inadvertently pulls the handlebar (42) or a force or shock is applied to the front wheel (43) when the user is riding the scooter, the pin (48) will disengage from the notches (462) and the connecting arm (477) with the handlebar (42) will unexpectedly fold. The scooter with the conventional folding device is not very safe.

To overcome the shortcomings, the present invention tends to provide an improved folding device to mitigate or obviate the aforementioned problems.

### SUMMARY OF THE INVENTION

The main objective of the invention is to provide an improved folding device for a scooter that will not fold unintentionally. The folding device has a bracket, a connecting arm and a locking arm. The bracket is attached to the board. The bracket has a curved top edge, a flat bottom and two pairs of aligned notches defined in the top edge of the bracket. The connecting arm is pivotally to the bracket between the notches with a pivot pin through a pair of aligned through holes in the bracket and a through hole in the connecting arm. A pin extends through the connecting arm and is received in one of the pairs of notches in the bracket. The locking arm has a pivot end and a locking end. The pivot end is pivotally attached to the outside of the bracket with the pivot pin. The locking end has a notch defined in a bottom of the locking arm. Consequently, the notch in the locking arm can engage the pin from a top of the pin. The pin is kept from disengaging from the recess. The handlebar cannot be unintentionally folded when the locking arm is engaged with the pin. The safety of using and carrying the scooter is improved.

Other objects, advantages and novel features of the invention will become more apparent from the following detailed description when taken in conjunction with the accompanying drawings.

### BRIEF DESCRIPTION OF THE DRAWINGS

FIG. 1 is a perspective view of a folding device for a scooter in accordance with the present invention;

FIG. 2 is an exploded perspective view of the folding device in FIG. 1;

FIG. 3 is a side plan view of the folding device in FIG. 1

FIG. 4 is a perspective view of a scooter with a conventional folding device in accordance with the prior art; and

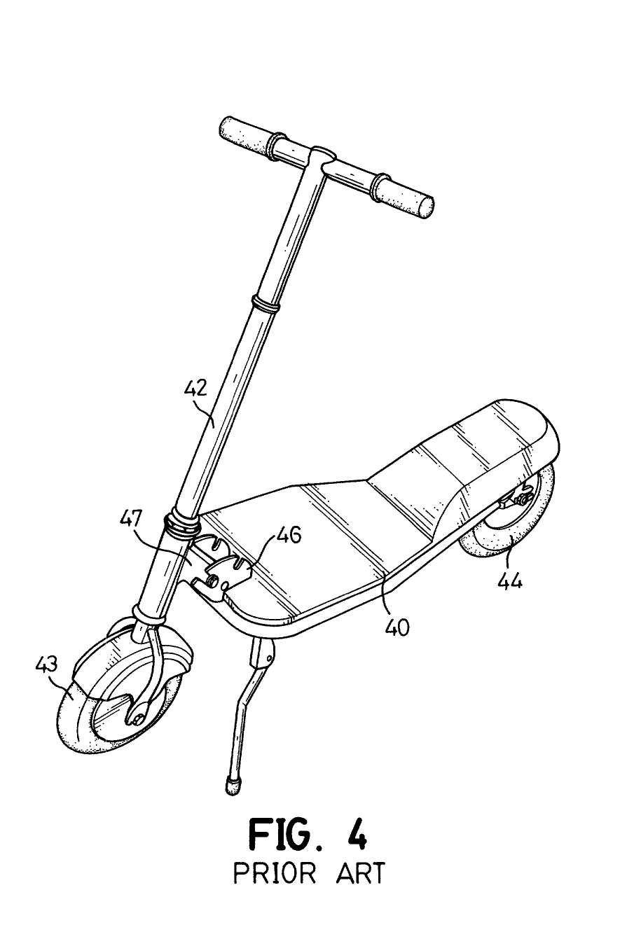

FIG. 5 is a side plan view of the conventional folding device in FIG. 4.

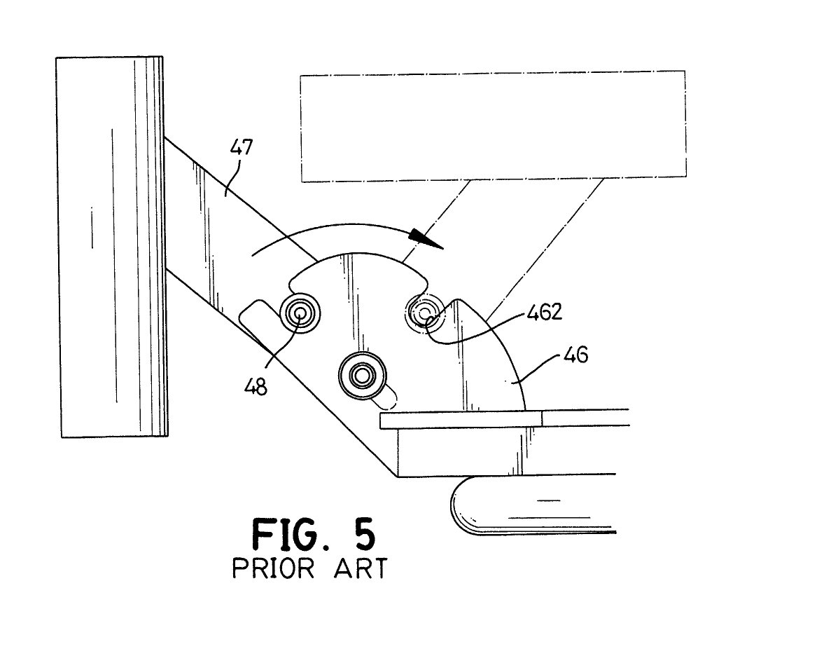

### DETAILED DESCRIPTION OF PREFERRED EMBODIMENT

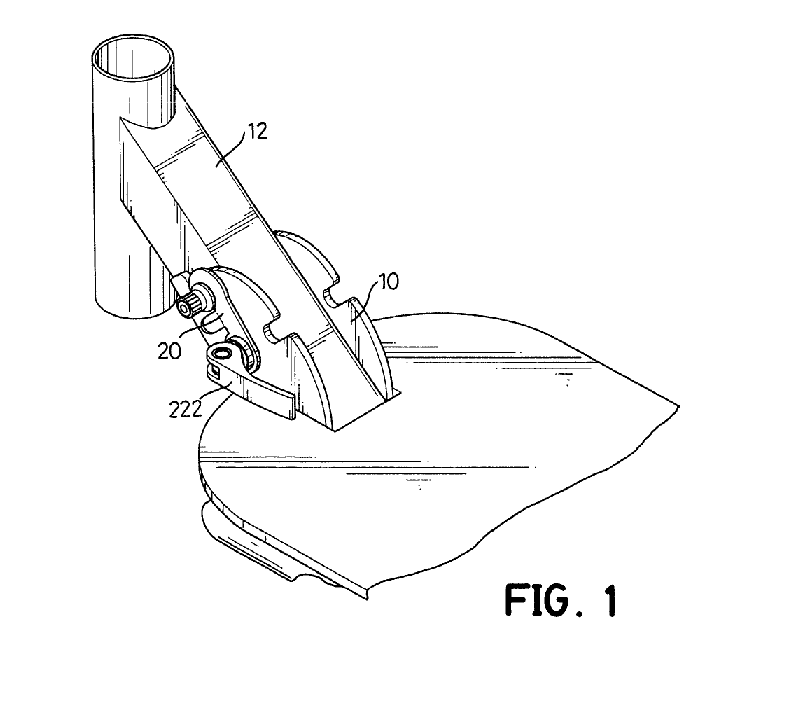

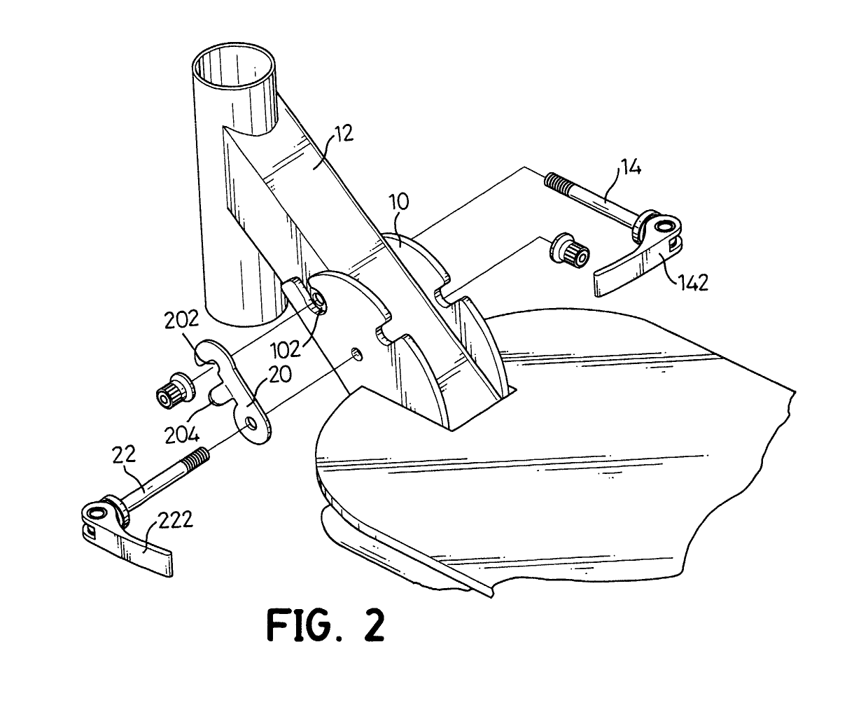

With reference to FIGS. 1 and 2, a folding device in accordance with the present invention comprises a bracket (10), a connecting arm (12) and a locking arm (20). The bracket (10) has a top edge and is attached to the board of the scooter. The top edge of the bracket (10) is a circular curve. The bracket (10) has two pairs of aligned notches (102) defined in the top edge of the plate (10).

The connecting arm (12) has two ends. One end of the connecting arm (12) is pivotally connected to the bracket (10) between the notches (102) in each pair. The other end of the connecting arm (12) is connected to a head tube (not numbered). A pin (14) extends through the connecting arm (12) and is received in one of the pairs of notches (102) in the bracket (10). With the pin (14) in either one of the pairs of notches (102), the connecting arm (12) cannot pivot relative to the bracket (10). In practice, a compression lever (142) is pivotally connected to the pin (14) to release or lock the pin (14). Because of the compression lever (142), the connecting arm (12) can be locked in an expanded or a folded position. A through slot (not shown) is defined in the connecting arm (12). The pivot pin (22) extends through the through slot in the connecting arm (12) and the bracket (10) so the connecting arm (12) is pivotally connected to the bracket (10) with the pivot pin (22).

The locking arm (20) is pivotally attached to outside of one side of the bracket (10) with the pivot pin (22). A notch (202) is defined in the bottom of the locking arm (20). A thumb tab (204) extends perpendicular out from the locking arm (20). In addition, a compression lever (222) is pivotally connected to the pivot pin (22) to release or lock the pivot pin (22) in the through slot. Because of the compression lever (222), the locking arm (20) can be locked and kept from sliding in the through slot.

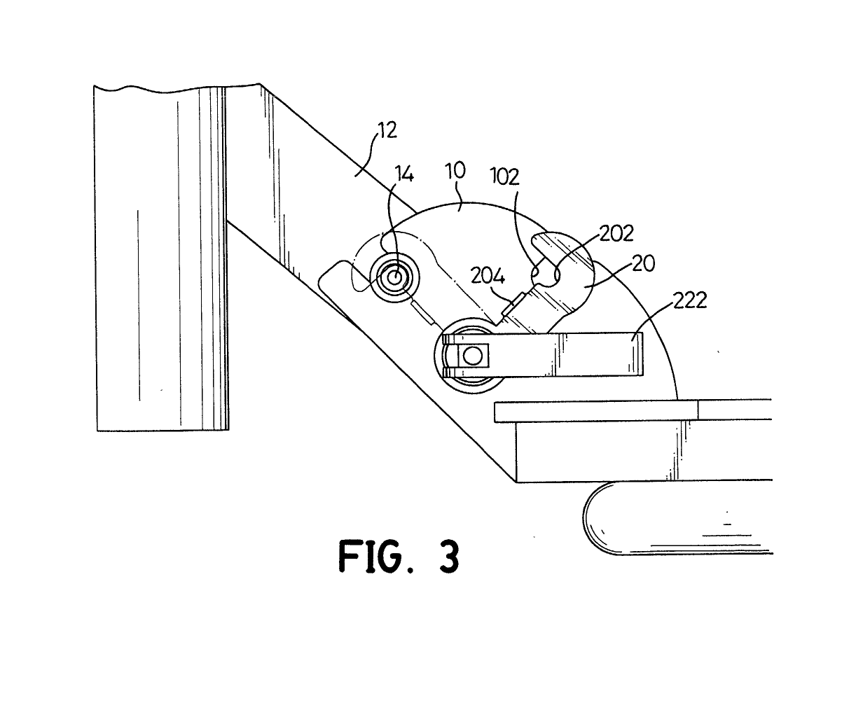

With reference to FIGS. 2 and 3, when the handlebar of the scooter is in an expanded position and the pin (14) is engaged in one of the notches (102), the locking arm (20) is rotated relative to the bracket (10), and the notch (202) in the locking arm (20) engages the pin (14). Because the notch (202) is defined in the bottom of the locking arm (20), the locking arm (20) engages the pin (14) from the top of the pin (14) to hold the pin (14) in position. This will provide a downward limitation to the pin (14) to keep the pin (14) from disengaging from the recess (102). Accordingly, the pin (14) will not disengage from the recess (102) even if the user pulls the handlebar of the scooter upward or a huge force or shock is applied to the front wheel of the scooter. The handlebar will not unintentionally fold when the scooter is in use. The safety of using the scooter is improved.

When the user wants to fold the scooter, he or she releases the compression levers (142, 222) and pivots the locking arm (20) by pulling the thumb tab (204) to disengage the locking arm (20) from the pin (14). Consequently, the limitation on the pin (14) is removed. The connecting arm (12) is pulled away from the pivot pin (22) so the slot slides along the pivot pin (22) the pin (14) clears the pair of notches (102). Then the folding device can be folded. The volume of the scooter can be reduced.

Even though numerous characteristics and advantages of the present invention have been set forth in the foregoing description, together with details of the structure and function of the invention, the disclosure is illustrative only, and changes may be made in detail, especially in matters of shape, size, and arrangement of parts within the principles of the invention to the full extent indicated by the broad general meaning of the terms in which the appended claims are expressed.

What is claimed is:

1. A folding device for a scooter having a board, a handlebar pivotally connected to one end of the board, a front wheel rotatably attached to a bottom of the handlebar and a rear wheel rotatably attached to the other end of the board, and the folding device comprising:
a bracket with a circular top edge adapted to be attached to the board and two pairs of aligned notches defined in the top edge of the bracket;
a connecting arm with two ends where one end is pivotally connected to the bracket between the notches in each pair with a pivot pin extending through a through slot in the connecting arm and the other end of the connecting arm connected to a head tube;
a pin extending through the connecting arm and received in either pair of notches in the bracket; and
a locking arm with two end where one end is pivotally attached to one side of the bracket by the pivot pin and the other end has a notch defined in a bottom of the locking arm to engage with the pin from a top of the pin.

2. The folding device as claimed in claim 1 further comprising a compression lever pivotally connected to the pin to lock the pin in either of the pairs of notches.

3. The folding device as claimed in claim 1 further comprising a compression lever pivotally connected to the pivot pin to lock the pivot pin in the slot in the connecting arm.

4. The folding device as claimed in claim 1, wherein the locking arm has a thumb tab extending perpendicular out from the locking arm.

5. The folding device as claimed in claim 1, wherein the locking arm is pivotally connected to the bracket with the pivot pin that pivotally connects the connecting arm to the bracket.
